(19) United States
(12) Patent Application Publication
(10) Pub. No.: US 2018/0002565 A1
(43) Pub. Date: Jan. 4, 2018

(54) AQUEOUS POLYMER COMPOSITIONS AND METHODS

(71) Applicant: GAPA Enterprises, Memphis, TN (US)

(72) Inventor: GREGG R. OVERMAN, Hernando, MS (US)

(73) Assignee: GAPA Enterprises, Memphis, TN (US)

(21) Appl. No.: 15/354,819

(22) Filed: Nov. 17, 2016

Related U.S. Application Data
(60) Provisional application No. 62/356,394, filed on Jun. 29, 2016.

(51) Int. Cl. C09D 167/08; C09D 7/12; C09D 7/00

(52) U.S. Cl. CPC C09D 167/08; C09D 7/002; C09D 7/1233

(57) ABSTRACT

Aqueous alkyd resin emulsion compositions and methods of applying them for providing exceptionally durable gloss sheen to a variety of surfaces, including, but not limited to, urethane rubber, vehicle tires, and vinyl, The emulsion compositions comprise an alkyd resin, a mixture of alkyd resins, a mixture of alkyd resins and conventional latex resins, or a mixture of all or part of the above and silicone oils. The emulsion compositions also comprise thickeners, metallic driers, defoamers, and/or preservatives. The methods generally comprise applying an alkyd resin emulsion composition to a substrate surface in need of treatment and allowing the composition to cure by oxidative polymerization on and within the surface.

### CROSS REFERENCE TO RELATED APPLICATIONS

This application claims priority to U.S. Provisional Application No. 62/356,394 to Gregg R. Overman filed Jun. 29, 2016, and which is incorporated herein by reference in its entirety.

### FIELD OF THE INVENTION

The present invention is generally directed toward compositions and methods related to water-borne polymer compositions and more specifically to waterborne, film-forming alkyd resin coatings.

### BACKGROUND OF THE INVENTION

The search for methods to preserve substrates from the depredations of wind, rain, sun, and microbial attack predates the recorded history of mankind. Perhaps the oldest is the use of simple oils, tars, and waxes to lend water repellency to wood and clothing. There are today literally thousands of products to choose from; each having particular strengths and weaknesses. However, some surfaces in need of protection or desirable of maintaining a “new” or “shiny” appearance have not been successfully treated with film-curing protectants.

One category of surfaces commonly treated is polymers, such as rubber vehicle tires and other polymer surfaces, including vinyl plastics. Numerous products are on the market that claim to provide gloss or sheen to vehicle tires and vinyl plastics. These can be broadly divided into two types: those that are temporary in nature and those that purport to be more durable or long lasting. The most common of the “temporary” tire shine/vinyl products are typically mixtures of silicone oils having viscosities from 100 centistokes to well over 10,000 centistokes. These are available as water-borne emulsions and solvent-borne solutions. Other temporary tire shine products can be made using polyethylene and/or polypropylene glycols of various molecular weight distributions. Tire shine/vinyl rejuvenation products have also been successfully produced using various natural gums dissolved in different solvents. All of these temporary treatment products function by filling in small dips and pinholes in the surface and then slumping or leveling to produce an optically flat surface. However, none of them will cure to form a film on the surface. After the solvent or water has evaporated, the products remain on the surface as high viscosity liquids. This brings with it the many problems inherent in this approach. The resulting high viscosity liquid is both sticky and mobile. The sticky nature of the liquid causes it to pick up and hold dust and dirt, resulting in a degraded appearance to the treated surface. Even if this does not occur, the high viscosity liquid can continue to soak into the surface of be slung off from a tire due to centrifugal forces acting on the tire when driving. In some cases, such as the silicone products, the liquid itself can slowly evaporate over a period of a few days. In all cases these products will be removed when the vehicle is next washed. The net result is a need to reapply the treatment every few days in order to preserve the appearance desired by many consumers. Furthermore, the “sling off” of material from centrifugal forces is not a small issue. Not only does it remove the product from the tire and lessen the desirable appearance, the resulting deposition of the tire shine product on wheel wells, fenders, and body panels causes unsightly and difficult to remove stains on these surfaces. There are also numerous products on the market that claim to leave a durable gloss or shine on vehicle tires. The reason these have not displaced the more temporary products in the marketplace is that they all suffer from one problem or another, such as: difficulties in application; the need to wait for several minutes or even hours between application and driving the vehicle; noxious and dangerous solvent carriers; cracking, peeling, and flaking from the tires; and, paradoxically, lack of longevity.

The advent of oil-borne alkyd coatings was a giant leap forward, as was the invention of water-borne latex emulsion technology. This progress in basic cured-film formation science has occurred alongside the discovery and development of numerous additives to enhance the ability of these coatings to withstand water, mold, mildew, and sunlight. Coatings based on alkyd chemistry have many advantages; chiefly their ability to penetrate substrates and subsequently cure into a hard film. The downside to alkyd coatings is that all of the useful formulations have historically been solvent-borne. Not only does this introduce health hazards, but current laws regarding VOC (Volatile Organic Compounds) emissions have all but precluded their use in most applications. Latex emulsions have fewer health concerns and can be formulated with low VOC content, but existing latex emulsions cannot penetrate into the surfaces to which they are applied. This greatly limits their application and development for surface coating technologies, including on polymer surfaces.

### SUMMARY OF THE INVENTION

The present invention provides compositions and methods to achieve a shine, gloss, or “new tire” look to urethane rubber, vehicle tires, and vinyl that is both durable and resistant to removal by washing with water and soap while avoiding most, if not all, of the problems currently associated with the technology as it exists today. The present invention is comprised of an aqueous alkyd resin composition which, when applied to a vehicle tire or to vinyl, will soak into the surface and cure to a flexible and resilient film by oxidative polymerization, allowing it to tightly adhere to the tire. This film, by virtue of its mechanical properties will lend a shine, gloss, or “new tire” look to the urethane rubber, vehicle tires, and/or vinyl which will last for up to eight weeks and will resist removal by ordinary washing with soap and water. The present invention furthermore produces a film that, by virtue of its ability to soak into and penetrate the urethane rubber, tire, or vinyl surface, it will not “sling off” of the surface (e.g., a tire under ordinary driving circumstances).

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

In 2008, Reichhold Chemical commercialized a true alkyd emulsion coatings resin under the trade name BECKOSOL. This material, for the first time, combined the superior penetrating ability of alkyd resins with the advantages of latex emulsions. The novel exploitation of these alkyd resin emulsions and the resultant unique film properties form the basis of this disclosure. Although Reichhold was the first to market with the alkyd resin technology, several other producers are now supplying similar materials. The alkyd resins used herein may be based on long, medium, or short oil alkyds. The alkyds used herein may include alkyd resins with epoxy, acrylic, urethane, styrene, vinyl ester, vinyl ether, silicone, or any number of other types of modifications, including combinations thereof.

The use of alkyd emulsions has not been fully explored for many surface treatment applications, and has never been explored as a component of urethane rubber, vehicle tire, and vinyl treatment compositions and methods of providing a durable shine or “new” look to urethane rubbers, rubber tires, and vinyl plastics. My research has shown that the ability of my alkyd emulsion-based. compositions to penetrate (absorb into) and adhere to (adsorb onto) a substrate surface to cure to a hard, resilient film imparts unique properties to urethane rubber, tire rubber, and vinyl treatment compositions. The resiliency of the cured film allows for the compositions to be applied to and maintain its durability on historically difficult to treat flexible surfaces, including fabrics and rubbers (e.g., clothing and vehicle tires). The resilience of the cured film allows for the compositions to be applied to and maintain a durable shine or gloss to vehicle tires and vinyl. I have found that some embodiments of my alkyd emulsion-based compositions can be utilized to provide an exceptionally durable glossy sheen on even the most difficult and flexible of surfaces such as rubber vehicle tires and vinyl plastics. Other materials, e.g., brick, concrete, wood, etc., can also be treated with the inventive compositions to provide an exceptionally durable glossy sheen. Furthermore, some embodiments of my alkyd emulsion-based compositions can be utilized to, without limitation, (1) provide structural support to the top layer of a variety of substrates (e.g., brick, concrete, wood, rubber, etc.); (2) provide extreme exterior durability to a variety of substrates (e.g., brick, concrete, wood, rubber, etc.) in the face of weather and other physical contacts (rain, sleet, snow, hail, foot traffic, etc.); (3) provide exceptional long-term water repellency to a variety of substrates (e.g., brick, concrete, wood, rubber, etc.); (4) provide exceptional long-term mold, mildew, and algae control in and on the cured film on and within a variety of substrates (e.g., brick, concrete, wood, rubber, etc.).

Described here is particularly preferred embodiment of an alkyd film-forming composition of the present invention for treating and/or protecting a urethane rubber, vehicle tire surface, and/or vinyl plastic surface, a long oil alkyd resin emulsion such as BECKOSOL, AQ 101 or an acrylic modified alkyd resin emulsion such as BECKOSOL AQ 510 is used at a concentration from 5% to 95% by weight and more preferably at a concentration from 25% to 80% by weight. In some preferred embodiments, a concentration greater than 30% by weight of the alkyd resin is utilized. In other preferred embodiments, a concentration greater than 80% by weight of the alkyd resin is utilized. My research has shown that BECKOSOL AQ 510 has great utility on rubber (e.g., urethane) surfaces and vinyl plastic surfaces, and, therefore, is the preferred resin base component for treating and/or protecting these types of material surfaces. A small amount (from 0.05% to 1.0% by weight) of a cellulosic thickener, such as hydroxyethyl cellulose or hydroxypropyl cellulose, is added for viscosity control; the target value being in the range of 50 to 50,000 centipoise as measured using a Brookfield RV viscometer at 20 RPM with the appropriate spindle (how to use an appropriate spindle is well-known in the art, e.g., #1 for ranges around 50 centipoise and #6 for ranges around 50,000 centipoise). A metallic drier suitable for aqueous systems, preferably BORCHI OXY-COAT from OMG Borchers, is incorporated at a rate of 0.1% to 3% of the weight of the alkyd emulsion as supplied in the composition. Other metallic driers known in the art (for example, cobalt, zirconium, manganese, calcium, zinc, copper, barium, vanadium, cerium, iron, potassium, strontium, aluminum, bismuth and lithium-containing compounds) can be adapted by a person of skill in the art based on the composition components and the substrate to be treated. Known, non-metallic driers are not preferred, but can be adapted for use in the compositions by a person of ordinary skill in the art without undue experimentation. A defoamer suitable for aqueous systems may be added at a rate of 0.01% to 1.0% of total batch size. An in-can preservative, such as Dow Chemical Company's BIOBAN 536, is preferably used at the level recommended by the manufacturer to insure stability of the product prior to application. The balance of the formula being water.

There are a number of BECKOSOL resins. BECKOSOL AQ 201, BECKOSOL AQ 206, BECKOSOL, AQ 400, BECKOSOL AQ 521 and other resins within this class of products, as well as analogues to these materials produced by manufactures other than Reichhold, may be used within the compositions and methods of the present invention, including for providing an alkyd resin film on rubber and vinyl plastic surfaces, as well as other material surfaces. My research has shown BECKOSOL AQ 101 to be preferable on wood surfaces, while BECKOSOL AQ 510 to have great utility on cementitious and rubber (urethane) surfaces. A person skilled in the art can use standard laboratory techniques to determine the advantages of these resins in a chosen application and/or a desired performance when applied to rubber (urethane), vehicle tires, or vinyl plastic surfaces, as well as other material surface types, following the present disclosure. Thus, a person of skill in the art will appreciate that, depending on the rubber or vinyl surface (or other surface material) to be treated, the particular resin base component chosen will provide different and/or better sheen and/or protectant characteristics. These or other alkyd resin emulsion base components may be used in compositions for treating and/or protecting other substrates (such as, and by way of example only: stone/masonry, tile, or fabric), which a person of skill in the art can readily determine following the teachings in this disclosure and with standard laboratory evaluation techniques. In practice, any of several different alkyd resin emulsions, mixtures of alkyd resin emulsions, or mixtures of alkyd resin emulsions and other commonly used latex emulsions, as well as mixtures of any of the above with the commonly used silicone oils and gums used in traditional tire and vinyl treatments may be used to achieve optimum performance of an embodiment of the alkyd resin compositions of the invention in polymer surface applications. In some embodiments, no unmodified short oil alkyd is used. In other embodiments, modified short oil alkyd is used. In further embodiments, unmodified long oil alkyds, unmodified medium oil alkyds, and combinations thereof are used. In still other embodiments, modified long oil alkyds, modified medium oil alkyds, and combinations thereof are used. In yet further embodiments, unmodified long oil alkyds, unmodified medium oil alkyds, modified long oil alkyds, modified medium oil alkyds, modified short oil alkyds, and combinations thereof are used.

My research has shown that the alkyd emulsion solids must comprise at least 30%, preferably 80%, and more preferably greater than 80%, of the overall coating solids in order to achieve the desired coating properties which will depend on the substrate to be treated among other considerations known in the industry. A person of skill in the art will understand that the “optimum performance” for the disclosed alkyd resin compositions will depend on the given application and its particularities, such as the degree of glossy sheen on tire rubber in a tire dressing application or a vinyl dressing, or other characteristics of non-polymer material surfaces, the duration of water repellency on wood in an exterior wood protectant application, or soaking in and subsequently hardening (curing) in order to lend structural support to the top layer of wood, asphalt, brick and fabric are just a few examples. These considerations can be evaluated by a person of skill in the art using well-known and routine laboratory techniques. My research has also shown that increased solids directly impacts the amount of shine or gloss on the surface while having relatively smaller influence on the longevity of the coating. A simple “new tire” look may be achieved at relatively low solids, while a high gloss “wet look” shine will require higher solids content on polymer surfaces. The amount of sheen or gloss can be adjusted as required or desired for other non-polymer material surfaces, such as wood and masonry applications.

The cellulosic thickeners above may be substituted with associative thickeners, acrylate, gum, clay, or other known and compatible thickeners or rheology modifiers, or combinations of these may be used. More or less than the preferred range of from 0.05% to 1.0% by weight may be used in order to achieve the target value range of 50 to 50,000 centipoise as measured using a Brookfield RV viscometer at 20 RPM with the appropriate spindle (how to use an appropriate spindle is well-known in the art, e.g., #1 for ranges around 50 centipoise and #6 for ranges around 50,000 centipoise). In some embodiments, thickeners and/or rheology modifiers may be omitted as unnecessary additives. A person of skill in the art will understand that the type and amount of thickener, when used in different embodiments, will depend on the substrate/application at issue, as well as other considerations such as to improve application/composition flow and customer perception. Further routine experimental investigation may be required by a person of ordinary skill in the art following the teachings provided herein and standard methods in the field in order to achieve the appropriate rheology for any given system and application.

The general application goal in which the alkyd resin compositions of the present invention may be of particular utility is to provide a durable gloss finish to a variety of substrates: polymer surfaces, especially vehicle tires, all types of rubber, urethane, and vinyl, but this statement should be understood to not be limiting to the full scope of the present invention.

For some material surfaces, more appropriate for masonry, tile, and wood material surfaces, biocides may be included for the prevention of mildew, mold, algae, or other undesirable microbial growth in and on the cured film in an application. Also, biocides may be included for prolonging the storage and/or application container(s). Acceptable biocides are well-known to those skilled in the art. An appropriate amount of a biocide (from 0.1 to 2.0%), such as Troy's POLYPHASE 678, is added in some embodiments for control of mildew, mold, and other microorganisms in and on the cured film. The amount of biocide will depend on a number of factors, including type, potency, and spectrum of biocide activity. Preferred biocides include POLYPHASE (3-iodo-2-propynyl butyl carbamate) in any of several forms and compositions available from Troy Chemical, various borate compositions (e.g., zinc borate), and the AMICAL or BIOBAN lines of products available from Dow Chemical. A person of skill in the art will recognize that these and many other biocides are available to paint and resin chemists, and any known and acceptable biocide may or may not be used either alone or combination, as deemed necessary for a given composition and/or its application.

The alkyd resin compositions of the present invention may exhibit high gloss on some substrate surfaces. In preferred embodiments, especially for applications of treating and/or protecting rubber, vehicle tire, and vinyl plastic surfaces, the glossy sheen of some compositions, once cured on and within the substrate, is resistant to water and soap washing. I have found that the durability of the glossy sheen on rubber tire surfaces, in one embodiment, can last for up to a month (28 days), eight weeks (56 days), or more. Additional agents, such as standard latex, may be included to enhance gloss in some applications. It should be understood, however, that there are applications where gloss is a detriment or otherwise undesirable. In these applications, various flatting agents such as fumed or precipitated silicas or certain known waxes may be used to reduce the gloss of the dried film.

For applications where greater water repellency is desired in the cured film, a water repellency agent may further provide some enhanced durability characteristics to the cured resilient film. A person of skill in the art will recognize that such desirability will depend on the intended application of any given alkyd resin composition of the present invention. A paraffin wax emulsion (from 0.5% to 5.0%), such as Michelman's MICHEM Emulsion products is added in some embodiments as a water repellency agent. A particularly preferred paraffin wax emulsion is ME 70158 from Michelman. However, it will be understood that some embodiments will use a different or no water repellency agent. Water repellency agents, such as paraffin, slack wax, or other wax in the aqueous emulsions, either anionic, nonionic, or cationic, are thus optional in general, but may be required for certain intended applications that benefit from water repellency. Other acceptable water repellency agents include various known silicone oils and/or siloxanes, various known fluoro-surfactants and fluoropolymers, as well as known powdered waxes (such as carnauba) or the afore-mentioned waxes may be used either alone or in combination with other known water repellent additives (either natural or synthetic) to achieve the desired water repellency characteristics for a given alkyd resin composition of the present invention and its intended application (material type surface). Those who are skilled in the art will understand that each substrate will respond differently to different water repellant agents and that in each case some routine investigation will be necessary in order to choose the most effective water repellent agent for maximum water repellency and longevity. For applications where water repellency is not critical for performance, a water repellency agent can be omitted.

The primary application goal of the alkyd resin compositions and methods of the present invention is to provide a durable gloss finish to a variety of substrates, such as polymer surfaces, especially vehicle tires, all types of rubber, urethane, and vinyl, as non-limiting examples. The alkyd resin compositions and methods of the present invention can also be used to provide a durable gloss finish to other substrate materials, including, but limited to, natural and synthetic masonry (e.g., brick, stone, grout, paving stones, tile, concrete, etc.); fabrics, including any number of synthetic fabrics (e.g., polyester, rayon, nylon, etc.) as well as natural fabrics (e.g., cotton, silk, wool, linen, canvas, etc.); asphaltic surfaces, such as asphalt driveways, parking lots, as well as asphalt shingle roofing and the tars and asphalts that are frequently used in roofing applications and for sealing exterior surfaces against water entry; and wood of all kinds and naturally occurring wood-like surfaces such as bamboo.

It will be understood by a person of skill in the art that in applications where a pigmented system is desired, the grind phase of the actual production will include various known dispersants and/or grinding resins. It is common practice to add a small amount (0.05% to 1.0%) of the grind weight of an appropriate in-process defoamer such as TROYKYD D230 at some point in the grind stage. The choice of dispersants and/or grinding resins will be determined by the pigments being ground and the total pigment loading but might include dispersants such as the TAMOL series from Dow Chemical or some of the SUPERSPERSE products from Eagle Specialty Products. Grinding resins could include members of the TEXICRYL line of products from Scott Bader Specialty Polymers or AROLON 845-W-45 from Reichhold. Titanium dioxide and various iron oxides, as well as many other inorganic and organic pigments, may be added to the grind phase. Applications to wood will greatly benefit from the inclusion of pigments in order to mitigate the destructive effects of ultra violet light. In many cases, exterior cementitious surfaces such as driveways or stucco will be pigmented to please the consumer. Applications to asphalt will generally require a lamp black or carbon black pigment to enhance the appearance of the coated surface. Applications to tires, interior stone, or masonry and fabric will, in general, be applied as a clear product without pigment. Unless otherwise specified by the supplier, the water repellent and the biocide (either in-can or for inhibition of microbial growth in the cured film) will be added to the letdown phase of production.

The letdown phase of production will include the alkyd emulsion and other additives (whether required or optional). These additives could include the biocide and/or the water repellency agent, as well as any wetting agents or rheological additives. In some cases, pre-dispersed pigments may be purchased from any number of suppliers, including Eagle Specialty Products, Chromatech, BASF, and many others. Prepackaged pigment dispersions are generally used when the pigment is difficult to grind or difficult to handle, such as carbon black, various transparent iron oxides, many organic pigments such as phthalocyanine pigments and any pigments supplied in particle sizes below 3 microns. Prepackaged pigment dispersion should, in general, be added in the letdown phase. It is common practice to add an appropriate defoamer such as a polysiloxane or fumed silica composition at the end of the letdown stage for control of foam during product application. Pigments, including dyes and other colorants, may be selected from any known coloring agent, including, but not limited to, the following: titanium dioxide, mica, calcium carbonate, silica, zinc oxide, milled glass, aluminum trihydrate, talc, silica oxide, alumina, zirconia, antimony trioxide, fly ash, clay, carbon black, pearlescent pigments, and colorants/coloring agents; as a yellow coloring agent, compounds typified by a condensed azo compound, an isoindolynone compound, an anthraquinone compound, an azometal complex methine compound, and an allylamide compound as pigments may be used; as a magenta coloring agent, a condensed azo compound, a diketopyrrolopyrrole compound, anthraquinone, a quinacridone compound, a base dye lake compound, a naphthol compound, a benzimidazolone compound, a thioindigo compound, and a perylene compound may be used; as a cyan coloring agent, a copper phthalocyanine compound and its derivative, an anthraquinone compound, a base dye lake compound, and the like may be used.

Some embodiments of the alkyd resin compositions and methods of the present invention also can be used to seal, protect, and/or provide structural support to the top layer of a variety of substrates: a variety of substrates, such as polymer surfaces, especially vehicle tires, all types of rubber, urethane, and vinyl, as non-limiting examples; natural and synthetic masonry (e.g., brick, stone, grout, paving stones, tile, concrete, etc.); fabrics, including any number of synthetic fabrics (e.g., polyester, rayon, nylon, etc.) as well as natural fabrics (e.g., cotton, silk, wool, linen, canvas, etc.); asphaltic surfaces, such as asphalt driveways, parking lots, as well as asphalt shingle roofing and the tars and asphalts that are frequently used in roofing applications and for sealing exterior surfaces against water entry; and wood of all kinds and naturally occurring wood-like surfaces such as bamboo.

Still other embodiments of the alkyd resin compositions and methods of the present invention also can be used to provide long-term water repellency, by the inclusion of appropriate hydrophobic agents (waxes, silicones, fluoro-surfactants and fluoropolymers, as well as others), to a variety of substrates: a variety of substrates, such as polymer surfaces, especially vehicle tires, all types of rubber, urethane, and vinyl, as non-limiting examples; natural and synthetic masonry (e.g., brick, stone, grout, paving stones, tile, concrete, etc.); fabrics, including any number of synthetic fabrics (e.g., polyester, rayon, nylon, etc.) as well as natural fabrics (e.g., cotton, silk, wool, linen, canvas, etc.); asphaltic surfaces, such as asphalt driveways, parking lots, as well as asphalt shingle roofing and the tars and asphalts that are frequently used in roofing applications and for sealing exterior surfaces against water entry; and wood of all kinds and naturally occurring wood-like surfaces such as bamboo.

Further embodiments of the alkyd resin compositions and methods of the present invention also can be used to provide protection to the cured film from attack by mold, mildew, moss, algae and/or microorganisms, by the inclusion of appropriate biocides, on and within a variety of substrates: a variety of substrates, such as polymer surfaces, especially vehicle tires, all types of rubber, urethane, and vinyl, as non-limiting examples; natural and synthetic masonry (e.g., brick, stone, grout, paving stones, tile, concrete, etc.); fabrics, including any number of synthetic fabrics (e.g., polyester, rayon, nylon, etc.) as well as natural fabrics (e.g., cotton, silk, wool, linen, canvas, etc.); asphaltic surfaces, such as asphalt driveways, parking lots, as well as asphalt shingle roofing and the tars and asphalts that are frequently used in roofing applications and tor sealing exterior surfaces against water entry; wood of all kinds and naturally occurring wood-like surfaces such as bamboo.

The method of application will vary depending on the substrate surface in need of treatment. My investigation has shown that the preferred method is spraying via a low pressure sprayer (either mechanical or pump-up) with a subsequent spreading of the product using a soft cloth or sponge to evenly distribute the material on the surface within a minute or two of the spray application. Optionally, the product may be poured onto a sponge or cloth and applied directly to the surface to be treated by wiping the sponge or cloth on the surface. In all cases, efforts should be made to insure an even application, and any obvious pools of excess liquid product should be wiped up/away before the product has begun to dry (two to ten minutes depending on humidity, temperature, substrate surface, and the product composition being used). For application to other substrates, the compositions may be rolled, brushed, sprayed (either mechanical or pump-up) or other method conventionally employed to apply a coating to a substrate in the industry. After application, the compositions cure by oxidative polymerization on and within the surface.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all sub-ranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

I claim:

1. An aqueous emulsion composition comprising an alkyd resin emulsion, a drier, a latex emulsion, and a silicone oil.

2. The aqueous emulsion composition of claim 1 further comprising an additive selected from the group consisting of a thickening agent, defoamer, a siloxane, a gum, a fluorosurfactant, a fluoropolymer, a biocide, a wax, and combinations thereof.

3. The aqueous emulsion composition of claim 2, wherein the thickening agent is in the range of 0.05% to 1.0% by weight of the total aqueous emulsion composition.

4. The aqueous emulsion composition of claim 3, wherein the thickening agent is a cellulosic thickener.

5. The aqueous emulsion composition of claim 3, wherein the thickening agent is an associative thickener.

6. The aqueous emulsion composition of claim 3, wherein the thickening agent is a clay.

7. The aqueous emulsion composition of claim 3, wherein the thickening agent is a gum.

8. The aqueous emulsion composition of claim 1, wherein the aqueous emulsion composition viscosity is in the range of 50 to 50,000 centipoise.

9. The aqueous emulsion composition of claim 1, wherein the alkyd resin emulsion comprises 30% to 80% of the total solids content of the aqueous emulsion composition.

10. The aqueous emulsion composition of claim 1, wherein the alkyd resin emulsion comprises greater than 80% of the total solids content f the aqueous emulsion composition.

11. The aqueous emulsion composition of claim 1, wherein alkyd resins of the alkyd resin emulsion are selected from the group consisting of a medium oil alkyd resin, a long oil alkyd resin, a modified alkyd resin, and combinations thereof.

12. The aqueous emulsion composition of claim 11, wherein the modification of the alkyd resins is selected from the group consisting of epoxy, acrylic, urethane, styrene, vinyl ester, vinyl ether, silicone, and combinations thereof.

13. The aqueous emulsion composition of claim 1, wherein the alkyd resin emulsion is a long oil alkyd resin emulsion.

14. The aqueous emulsion composition of claim 1, wherein the alkyd resin emulsion is a medium oil alkyd resin emulsion.

15. The aqueous emulsion composition of claim 1, wherein the alkyd resin emulsion is a short oil alkyd resin emulsion.

16. The aqueous emulsion composition of claim 1, wherein the alkyd resin emulsion is an acrylic modified alkyd resin emulsion.

7. The aqueous emulsion composition of claim 16, wherein the acrylic modified alkyd resin emulsion is in the range of 5% to 95% by weight of the total aqueous emulsion composition.

18. The aqueous emulsion composition of claim 1, wherein the drier is a metallic drier.

19. The aqueous emulsion composition of claim 1, wherein the drier is a non-metallic drier.

20. A method of forming a durable film coating on a surface, comprising: applying to the surface an aqueous emulsion composition comprising an alkyd resin emulsion, a drier, a latex emulsion, and a silicone oil.

21. The method of claim 20, wherein the surface is selected from the group consisting of a vehicle tire surface, a rubber surface, and a vinyl surface.

22. The method of claim 20, wherein the aqueous emulsion composition cures to a resilient film on the surface.

23. The method of claim 20, wherein the alkyd resin emulsion comprises 30% to 80% of the total solids content of the aqueous emulsion composition.

24. The method of claim 20, wherein the alkyd resin emulsion comprises greater than 80% of the total solids content of the aqueous emulsion composition.

25. The method of claim 20, wherein alkyd resins of the alkyd resin emulsion are selected from the group consisting of a medium oil alkyd resin, a long oil alkyd resin, a modified alkyd resin, and combinations thereof.

26. The method of claim 25, wherein the modification of alkyd resins of the alkyd resin emulsion is selected from the group consisting of epoxy, acrylic, urethane, styrene, vinyl ester, vinyl ether, silicone, and combinations thereof.

27. The method of claim 20, wherein the alkyd resin emulsion is a long oil alkyd resin emulsion.

28. The method of claim 20, wherein the alkyd resin emulsion is an acrylic modified alkyd resin emulsion.

29. The method of claim 28, wherein the acrylic modified alkyd resin emulsion is in the range of 5% to 95% by weight of the total aqueous emulsion composition.

30. The method of claim 20, wherein the aqueous emulsion composition penetrates into the surface, thereby preventing sling off of the durable film coating.

31. The method of claim 20, wherein the drier is a metallic drier.

32. The method of claim 20, wherein the drier is a non-metallic drier.

33. The method of claim 20, wherein the durable film coating lasts up to fifty-six days on the surface.

34. The method of claim 20, wherein the durable film coating is resistant to water and soap washing.

35. A method of forming a resilient, glossy sheen on a surface, comprising: applying to the surface an aqueous emulsion composition comprising an alkyd resin emulsion, a drier, a latex emulsion, and a silicone oil.

36. The method of claim 35, wherein the surface is selected from the group consisting of a vehicle tire surface, a rubber surface, and a vinyl surface.

37. The method of claim 35, wherein the aqueous emulsion composition cures to a resilient film on the surface.

38. The method of claim 37, wherein the aqueous emulsion composition penetrates into the surface, thereby preventing sling off of the resilient film.

39. The method of claim 37, wherein the durable film coating lasts up to fifty-six days on the surface.

40. The method of claim 37, wherein the resilient film is resistant to water and soap washing.

41. The method of claim 35, wherein the alkyd resin emulsion comprises 30% to 80% of the total solids content of the aqueous emulsion composition.

42. The method of claim 35, wherein the alkyd resin emulsion comprises greater than 80% of the total solids content of the aqueous emulsion composition.

43. The method of claim 35, wherein alkyd resins of the alkyd resin emulsion are selected from the group consisting of a short oil alkyd resin, medium oil alkyd resin, a long oil alkyd resin, a modified alkyd resin, and combinations thereof.

44. The method of claim 43, wherein the modification of alkyd resins of the alkyd resin emulsion is selected from the group consisting of epoxy, acrylic, urethane, styrene, vinyl ester, vinyl ether, silicone, and combinations thereof.

45. The method of claim 35, wherein the alkyd resin emulsion is a long oil alkyd resin emulsion.

46. The method of claim 35, wherein the alkyd resin emulsion is a medium oil alkyd resin emulsion.

47. The method of claim 35, wherein the alkyd resin emulsion is a short oil alkyd resin emulsion.

48. The method of claim 35, wherein the alkyd resin emulsion is an acrylic modified alkyd resin emulsion.

49. The method of claim 48, wherein the acrylic modified alkyd resin emulsion is in the range of 5% to 95% by weight of the total aqueous emulsion composition.

50. The method of claim 35, wherein the drier is a metallic drier.

51. The method of claim 35, wherein the drier is a non-metallic drier.
